(19) United States
(12) Patent Application Publication
(10) Pub. No.: US 2026/0180039 A1
(43) Pub. Date: Jun. 25, 2026

(54) ENHANCED BATTERY CONTROL BOX WITH SEMICONDUCTOR SWITCHES FOR INTERFACING OF BATTERIES TO INVERTERS

(71) Applicant: GE Infrastructure Technology LLC, Greenville, SC (US)

(72) Inventors: Chester Stanley JEZIERSKI, JR., Amsterdam, NY (US); Owen Jannis SCHELENZ, Berlin (DE)

(73) Assignee: GE Infrastructure Technology LLC, Greenville, SC (US)

(21) Appl. No.: 18/989,385

(22) Filed: Dec. 20, 2024

(51) Int. Cl. H01M 10/42; H01M 50/583

(52) U.S. Cl. CPC H01M 10/425; H01M 50/583; H01M 2010/4271

(57) ABSTRACT

Devices, systems, and methods for interfacing a battery with an inverter may include a first fuse connecting to a positive pole of the battery; a second fuse connecting to a negative pole of the battery; and at least one semiconductor switch on at least one of the positive pole or the negative pole, wherein the at least one semiconductor switch stops current flow to a short on at least a first side of the electrical control box proximate to the battery or a second side of the electrical control box proximate to the inverter.

### TECHNICAL FIELD

This disclosure generally relates to battery interfaces, and specifically to interfaces between batteries and inverters.

### BACKGROUND

The main ways that batteries interface with inverters are using a control box or a DC/DC (direct current) converter.

### SUMMARY

An electrical control box interfacing a battery to an inverter may include a first fuse connecting to a positive pole of the battery; a second fuse connecting to a negative pole of the battery; and at least one semiconductor switch on at least one of the positive pole or the negative pole, wherein the at least one semiconductor switch is configured to stop current flow to a short on at least a first side of the electrical control box proximate to the battery or a second side of the electrical control box proximate to the inverter.

A system for interfacing a battery to an inverter may include a battery; an inverter; and an electrical control box interfacing the battery to the inverter, wherein the electrical control box includes: a first fuse connecting to a positive pole of the battery; a second fuse connecting to a negative pole of the battery; and at least one semiconductor switch on at least one of the positive pole or the negative pole, wherein the at least one semiconductor switch is configured to stop current flow to a short on at least a first side of the electrical control box proximate to the battery or a second side of the electrical control box proximate to the inverter.

A device for interfacing a battery to an inverter may include a first fuse connecting to a positive pole of the battery; a second fuse connecting to a negative pole of the battery; and at least one semiconductor switch on at least one of the positive pole or the negative pole, wherein the at least one semiconductor switch is configured to stop current flow to a short on at least a first side of the electrical control box proximate to the battery or a second side of the electrical control box proximate to the inverter.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system for interfacing batteries with inverters in accordance with one embodiment of the present disclosure.

FIG. 2 illustrates an example system for interfacing batteries with inverters in accordance with one embodiment of the present disclosure.

FIG. 3 illustrates an example system for interfacing batteries with inverters in accordance with one embodiment of the present disclosure.

FIG. 4 illustrates an example system for interfacing batteries with inverters in accordance with one embodiment of the present disclosure.

FIG. 5 illustrates an example system for interfacing batteries with inverters in accordance with one embodiment of the present disclosure.

FIG. 6 illustrates an example system for interfacing batteries with inverters in accordance with one embodiment of the present disclosure.

FIG. 7 illustrates an example system for interfacing batteries with inverters in accordance with one embodiment of the present disclosure.

FIG. 8 illustrates an example system for interfacing batteries with inverters in accordance with one embodiment of the present disclosure.

FIG. 9 shows example electronic switches used in FIGS. 1-8 and their characteristics in accordance with one embodiment of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The two general ways that batteries interface with inverters are via a control box or via DC/DC (direct current) converters. The control boxes may include electromechanical contactors that either open or close and electrically connect a battery to or disconnect a battery from an inverter's DC terminals. The DC/DC converters may raise and/or lower battery or inverter voltage to match each other.

The present disclosure provides an enhanced control box for interfacing a battery with an inverter. The enhanced control box herein may not include DC/DC converters or varying voltage, but may include semiconductor switches (e.g., metal-oxide-semiconductor field-effect transistors MOSFETs, insulated-gate bipolar transistors IGBTs, which may quickly (e.g., within microseconds) interrupt fault current (e.g., from the battery or the inverter).

Battery systems, especially Lithium-Ion battery systems, have a significant short circuit current capability (e.g., hundreds of thousands of amps). It is desirable to cut off the fault current flow very quickly when there is a fault (e.g., short circuit) to limit the short circuit current before the short circuit current reaches its full potential value. The enhanced semiconductor switch designs herein provide expedited interruption of fault/short circuit current when a fault occurs.

In one or more embodiments, the enhanced semiconductor switching mechanisms herein for control boxes may open/turn off a semiconductor switch when the fault current threshold or rate of fault current increase exceeds a threshold current, allowing for a microsecond-level response to the rising fault current. As a result, the fault current is cut off more quickly and at a lower level, and the enhanced techniques and designs herein reduce the resources needed to protect battery-converter circuits.

In existing battery control boxes, for example, fuses are the primary fault current interruption devices, and they blow to stop the fault current flow, requiring subsequent replacement. Because the semiconductor switches in the enhanced control box herein turn off current on the order of 1,000 times faster than fuses, the semiconductor switches herein provide a primary fault current interruption device. When the semiconductor switches interrupt a fault current, the fuses of the control box do not blow and need to be replaced, and the fuses may provide secondary current interruption devices.

Technical benefits of the enhanced designs herein include significant reduction in fault current flow magnitude and duration, as well as arc flash energy density, during an electrical fault event such as a short circuit. In addition, fewer fuses in the control boxes will blow and need to be replaced, and the amount of electrical conductor and mechanical structure resources to interrupt fault current is reduced. Compared to a DC/DC converter, the enhanced control box herein includes fewer parts. In addition, the enhanced control box herein is safer than existing control boxes for interfacing batteries and converters because the enhanced control box significantly reduces arc flash energy density during a fault event.

In one embodiment, the control box may include a single IGBT module on the positive pole of a battery for which the control box provides an interface with a bi-directional inverter. The IGBT module may include a freewheeling diode, and may stop current flow to a short on the inverter side of the control box. The freewheeling diode may allow uncontrolled current flow to a short on the battery side of the control box. As a result, the IGBT module may protect against a short on the inverter side of the control box.

In one embodiment, the control box may include two anti-parallel discrete IGBTs on the positive pole of a battery for which the control box provides an interface with a bi-directional inverter. The lower IGBT stops the current flow to a short on the inverter side of the control box, and the upper IGBT stops the current flow to a short on the battery side of the control box. As a result, the anti-parallel discrete IGBTs protect against a short on either side of the control box.

In one embodiment, the control box may include two anti-series IGBT modules on the positive pole of a battery for which the control box provides an interface with a bi-directional inverter. The IGBT modules each may include a freewheeling diode. The left IGBT may stop current flow to a short on the inverter side of the control box, and the right IGBT may stop current flow to a short on the battery side of the control box. As a result, the two anti-series IGBT modules may protect against a short on either side of the control box.

In one embodiment, the control box may include two anti-series IGBT modules, one on the positive pole of a battery for which the control box provides an interface with a bi-directional inverter, and one on the negative pole of the battery. The IGBT modules each may include a freewheeling diode. The positive pole IGBT may stop current flow to a short on the inverter side of the control box, and the negative pole IGBT may stop current flow to a short on the battery side of the control box. As a result, the two anti-series IGBT modules may protect against a short on either side of the control box.

In one embodiment, the control box may include a single MOSFET on the positive pole of a battery for which the control box provides an interface with a bi-directional inverter. The MOSFET may include a body diode and may stop current flow to a short on the inverter side of the control box. The body diode may allow uncontrolled current flow to a short on the battery side of the control box. As a result, the MOSFET may protect against a short on the inverter side of the control box.

In one embodiment, the control box may include two anti-series MOSFETs on the positive pole of a battery for which the control box provides an interface with a bi-directional inverter. The MOSFETs each may include a body diode. The left MOSFET may stop current flow to a short on the inverter side of the control box, and the right MOSFET may stop current flow to a short on the battery side of the control box. As a result, the two anti-series MOSFETs may protect against a short on either side of the control box.

In one embodiment, the control box may include two anti-series MOSFETs, one on the positive pole of a battery for which the control box provides an interface with a bi-directional inverter, and one on the negative pole of the battery. The MOSFETs each may include a body diode. The positive pole MOSFET may stop current flow to a short on the inverter side of the control box, and the negative pole MOSFET may stop current flow to a short on the battery side of the control box. As a result, the two anti-series MOSFETs may protect against a short on either side of the control box.

In one embodiment, the control box may include two anti-parallel gate turn-off thyristors (GTOs) on the positive pole of a battery for which the control box provides an interface with a bi-directional inverter. The lower GTO may stop current flow to a short on the inverter side of the control box, and the upper GTO may stop current flow to a short on the battery side of the control box. As a result, the two anti-parallel GTOs may protect against a short on either side of the control box.

The above descriptions are for purposes of illustration and are not meant to be limiting. Numerous other examples, configurations, processes, etc., may exist, some of which are described in greater detail below. Example embodiments will now be described with reference to the accompanying figures.

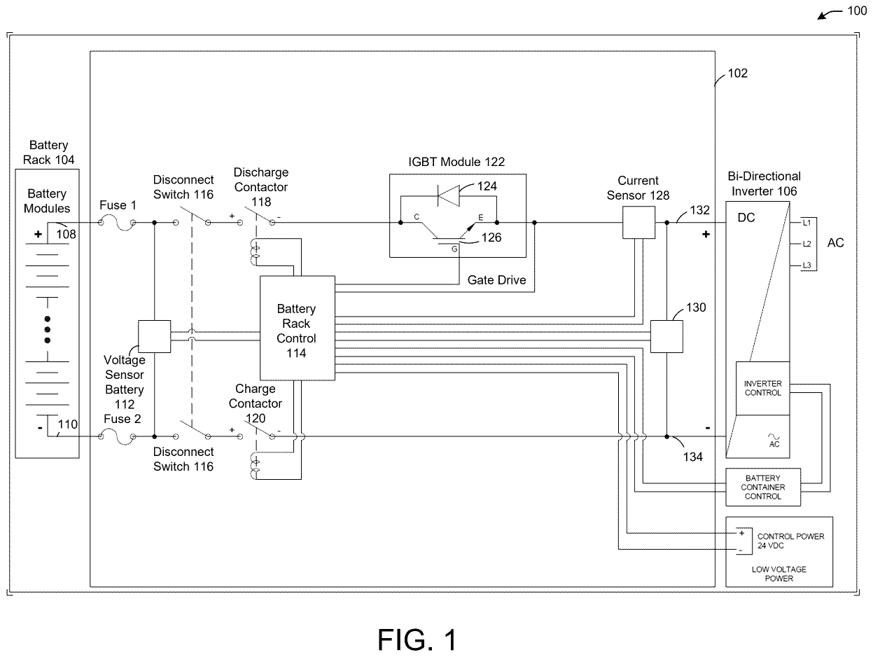

FIG. 1 illustrates an example system 100 for interfacing batteries with inverters in accordance with one embodiment of the present disclosure.

Referring to FIG. 1, the system 100 may include a control box 102 as an interface for a battery rack 104 of battery modules and an inverter (e.g., a bi-directional inverter 106). A positive pole 108 of the battery rack 104 may connect to the control box 102 via fuse 1, and a negative pole 110 of the battery rack 104 may connect to the control box 102 via fuse 2. A voltage battery sensor battery 112 may provide power to a battery rack control 114. Disconnect switches 116 may connect the positive pole 108 and the negative pole 110 to a discharge contactor 118 and to a charge contactor 120, respectively. An IGBT module 122 on the positive pole 108 may include a freewheeling diode 124 and a transistor 126 whose gate connects to the battery rack control 114 may stop current flow on the inverter side of the control box 102 (e.g., the right side of the page, proximate the bi-directional inverter 106). The freewheeling diode 124 may allow uncontrolled current flow to a short on the battery side of the control box 102 (e.g., the left side proximate the battery rack 104). As a result, the IGBT module 122 may protect against a short on the inverter side of the control box 102. A current sensor 128 on a positive pole 132 of the bi-directional inverter 106 may detect current flow, allowing for detection of a short. A voltage sensor inverter 130 may connect to the positive pole 132 of the bi-directional inverter 106 and a negative pole 134 of the bi-directional inverter 106.

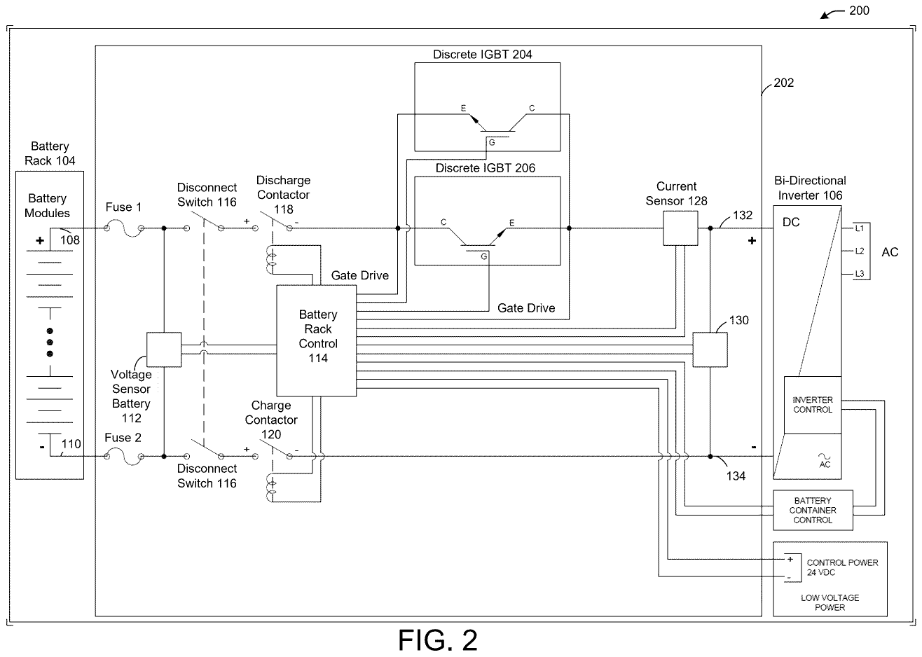

FIG. 2 illustrates an example system 200 for interfacing batteries with inverters in accordance with one embodiment of the present disclosure.

Referring to FIG. 2, the system 200 may include a control box 202 as an interface for a battery rack 104 of battery modules and an inverter (e.g., a bi-directional inverter 106). In contrast with FIG. 1, the control box 202 may include two anti-parallel discrete IGBTs (e.g., IGBT 204, IGBT 206) on the positive pole 108. The lower IGBT 206 stops current flow on a short on the inverter side of the control box 202, and the upper IGBT 204 stops current flow to a short on the battery side of the control box 202. As a result, the IGBTs in the control box 202 protect against a short on either side of the control box 202.

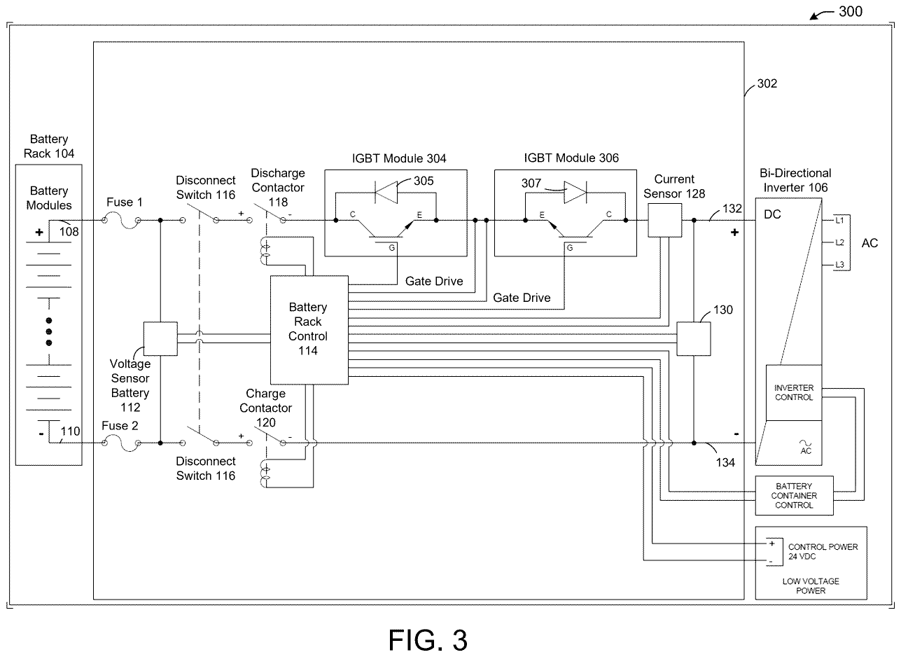

FIG. 3 illustrates an example system 300 for interfacing batteries with inverters in accordance with one embodiment of the present disclosure.

Referring to FIG. 3, the system 300 may include a control box 302 as an interface for a battery rack 104 of battery modules and an inverter (e.g., a bi-directional inverter 106). In contrast with FIG. 1, the control box 302 may include two-anti series IGBT modules (e.g., IGBT module 304 with freewheeling diode 305, IGBT module 306 with freewheeling diode 307) on the positive pole 108, each including a free-wheeling diode and a transistor. The IGBT module 304 stops current flow to a short on the inverter side of the control box 302, and the IGBT module 306 stops current flow to a short on the battery side of the control box. As a result, the IGBT modules protect against a short on either side of the control box 302.

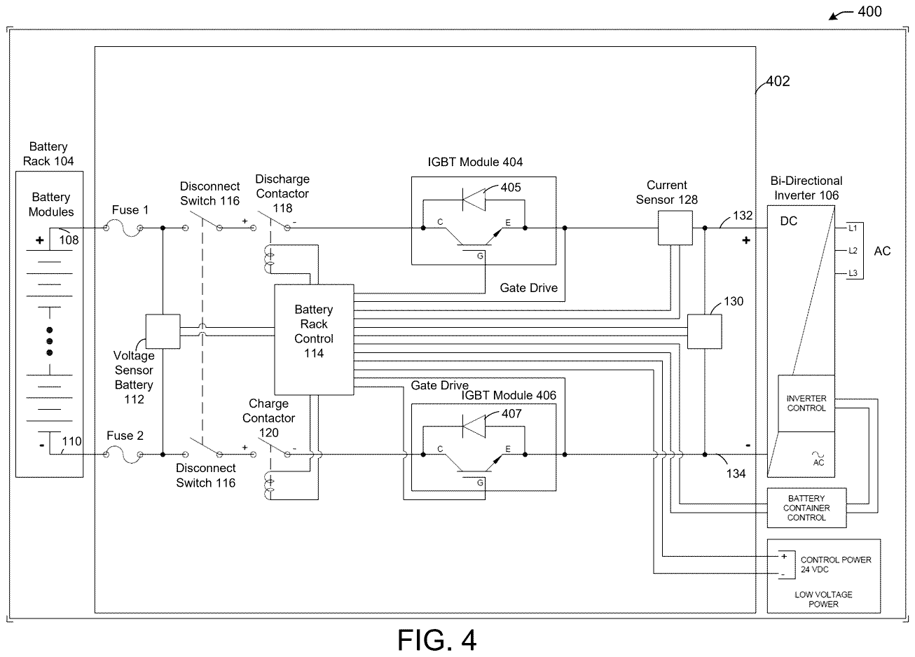

FIG. 4 illustrates an example system 400 for interfacing batteries with inverters in accordance with one embodiment of the present disclosure.

Referring to FIG. 4, the system 400 may include a control box 402 as an interface for a battery rack 104 of battery modules and an inverter (e.g., a bi-directional inverter 106). In contrast with FIG. 1, the control box 402 may include two anti-series IGBT modules (IGBT module 404 with freewheeling diode 407, IGBT module 406 with freewheeling diode 407) on the positive pole 108 and the negative pole 110, respectively. The IGBT module 404 on the positive pole 108 stops current flow to a short on the inverter side of the control box 402, and the IGBT module 406 stops current flow to a short on the battery side of the control box 402. As a result, the IGBT modules protect against a short on either side of the control box 402.

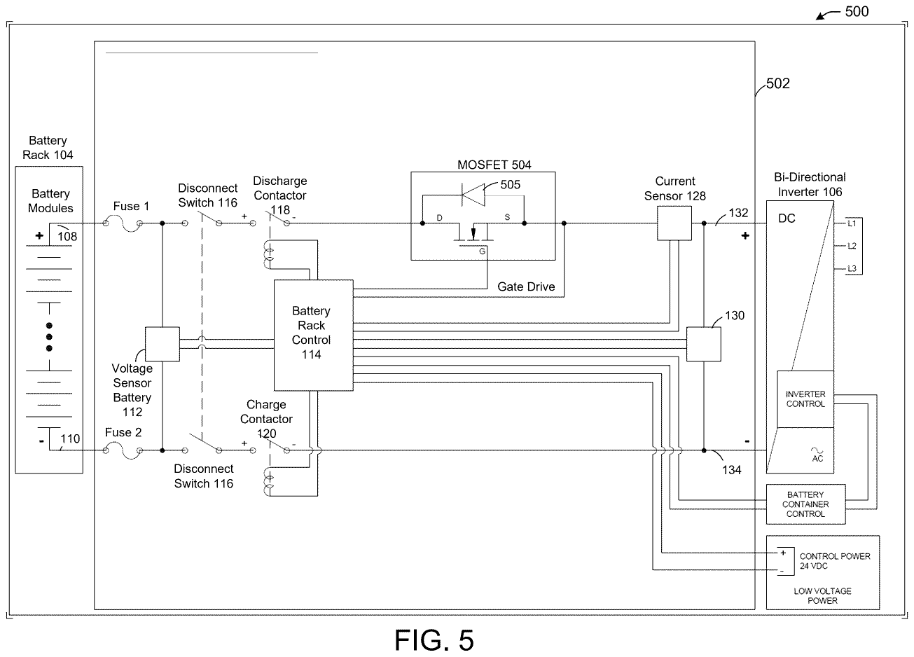

FIG. 5 illustrates an example system 500 for interfacing batteries with inverters in accordance with one embodiment of the present disclosure.

Referring to FIG. 5, the system 500 may include a control box 502 as an interface for a battery rack 104 of battery modules and an inverter (e.g., a bi-directional inverter 106). In contrast with FIG. 1, the control box 502 may include one MOSFET 504 (e.g., with body diode 505) on the positive pole 108. The MOSFET 504 may stop current flow to a short on the inverter side of the control box 502. A body diode of the MOSFET 504 allows uncontrolled current flow to a short on the battery side of the control box 502. As a result, the MOSFET 504 protects against a short on the inverter side of the control box 502.

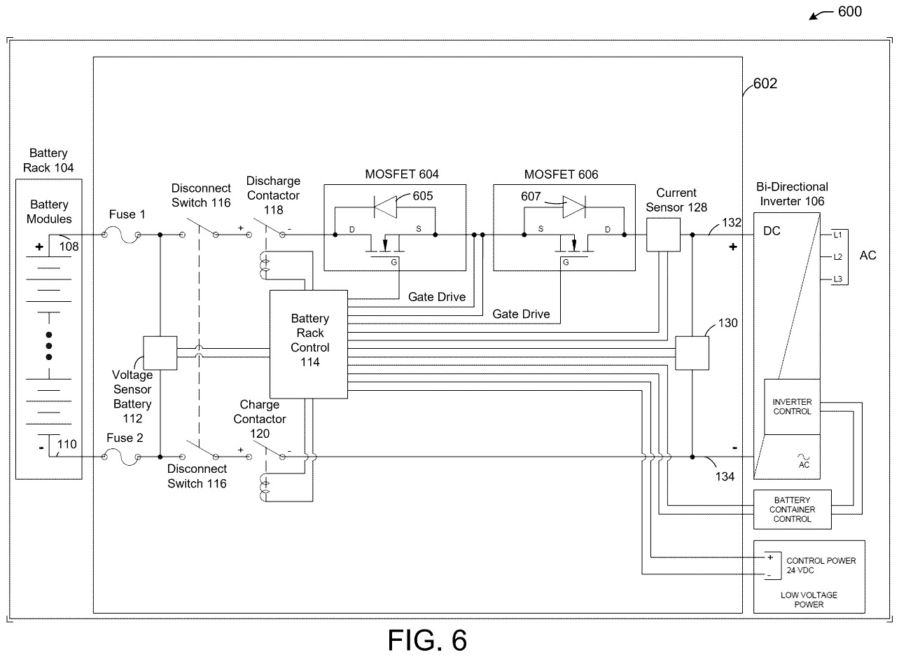

FIG. 6 illustrates an example system 600 for interfacing batteries with inverters in accordance with one embodiment of the present disclosure.

Referring to FIG. 6, the system 600 may include a control box 602 as an interface for a battery rack 104 of battery modules and an inverter (e.g., a bi-directional inverter 106). In contrast with FIG. 1, the control box 602 may include two anti-series MOSFETs (e.g., MOSFET 604 with body diode 605, MOSFET 606 with body diode 607) on the positive pole 108. The MOSFET 604 stops current flow to a short on the inverter side of the control box 602, and the MOSFET 606 stops current flow to a short on the battery side of the control box. As a result, the MOSFETs protect against a short on either side of the control box 602.

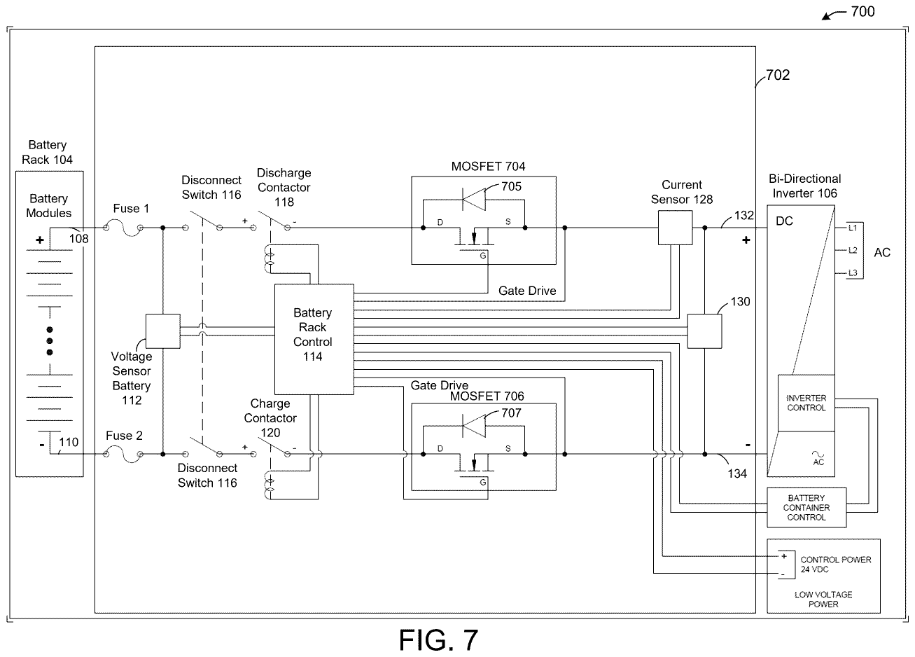

FIG. 7 illustrates an example system 700 for interfacing batteries with inverters in accordance with one embodiment of the present disclosure.

Referring to FIG. 7, the system 700 may include a control box 702 as an interface for a battery rack 104 of battery modules and an inverter (e.g., a bi-directional inverter 106). In contrast with FIG. 1, the control box 702 may include two anti-series MOSFETs (e.g., MOSFET 704 with body diode 705, MOSFET 706 with body diode 707), one on the positive pole 108 and one on the negative pole 110. The MOSFET 704 on the positive pole 108 stops current flow to a short on the inverter side of the control box 702. The MOSFET 706 on the negative pole 110 stops current flow to a short on the battery side of the control box 702. As a result, the MOSFETs protect against a short on either side of the control box 702.

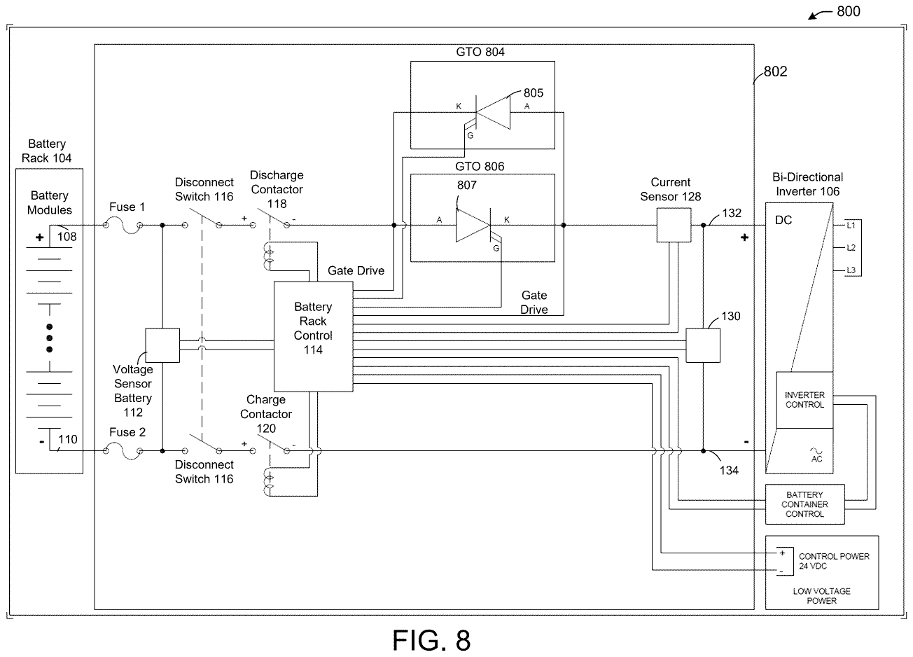

FIG. 8 illustrates an example system 800 for interfacing batteries with inverters in accordance with one embodiment of the present disclosure.

Referring to FIG. 8, the system 800 may include a control box 802 as an interface for a battery rack 104 of battery modules and an inverter (e.g., a bi-directional inverter 106). In contrast with FIG. 1, the control box 802 may include two anti-parallel GTOs (e.g., GTO 804 with device 805, GTO 806 with device 807) on the positive pole 108. The GTO 806 stops current flow to a short on the inverter side of the control box 802, and the GTO 804 stops current flow to a short on the battery side of the control box 802. As a result, the GTOs protect against a short on either side of the control box 802.

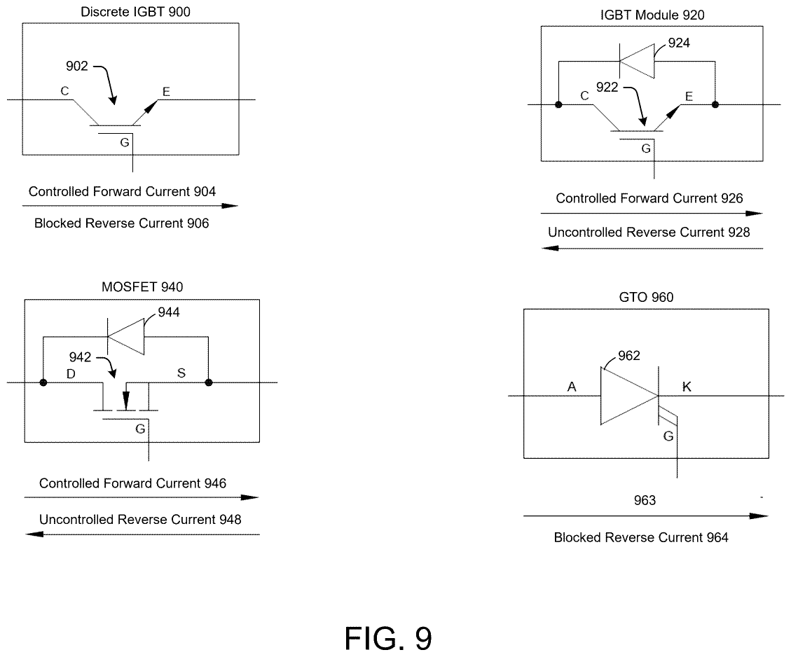

FIG. 9 shows example electronic switches used in FIGS. 1-8 and their characteristics in accordance with one embodiment of the present disclosure.

Referring to FIG. 9, discrete IGBT 900 may represent the IGBT 204 and the IGBT 206 of FIG. 2, for example. The discrete IGBT 900 may include a transistor 902, which may provide controlled forward current 904 and a blocked reverse current 906 because the discrete IGBT 900 does not conduct in the reverse direction.

Still referring to FIG. 9, an IGBT module 920 may represent the IGBT module 122 of FIG. 1, the IGBT module 304 and the IGBT module 306 of FIG. 3, the IGBT module 404 and the IGBT module 406 of FIG. 4. The IGBT module 920 may include a transistor 922 and a freewheeling diode 924. As a result, the IGBT module 920 may allow controlled forward current 926 and uncontrolled reverse current 928 because the IGBT module 920 conducts in the reverse direction and the diode voltage drop curve does not change with gate drive voltage.

Still referring to FIG. 9, a MOSFET 940 may represent the MOSFET 504 of FIG. 5, the MOSFET 604 and the MOSFET 606 of FIG. 6, and the MOSFET 704 and the MOSFET 706 of FIG. 7. The MOSFET 940 may include a transistor 942 and a body diode 944. As a result, the MOSFET 940 may allow controlled forward current 946 and uncontrolled reverse current 948 because the MOSFET 940 conducts in the reverse direction. Because the parasitic body diode 944 is part of the MOSFET 940 semiconductor, the diode drop curve changes with gate drive voltage, and for minimum reverse voltage drop and maximum electrical efficiency, the MOSFET 940 may be gated at its highest gate drive voltage.

Still referring to FIG. 9, a GTO 960 with device 962 may represent the GTO 804 and the GTO 806 of FIG. 8. The GTO 960 does not include a freewheeling diode or body diode, so it does not conduct in the reverse direction. As a result, the GTO 960 allows controlled forward current 963 and blocked reverse current 964.

In one or more embodiments, the enhanced semiconductor switching designs and techniques of the battery boxes herein result in improved efficiencies as shown below in Table 1. Using the following assumption, Table 1 shows improved efficiencies for discharge and charge: discharge current=75 Amps, charge current=75 Amps, voltage=1300 Volts:

TABLE 1
Improved Efficiencies of Battery Box Designs:

| | | Discharge | Charge |
|---|---|---|---|
| Configuration | Protection | Efficiency | Efficiency |
| FIG. 1 | Short on inverter | 99.88% | 99.90% |
| | side of control box | | |
| FIG. 2 | Short on either side | 99.88% | 99.88% |
| | of control box | | |
| FIG. 3 | Short on either side | 99.78% | 99.78% |
| | of control box | | |
| FIG. 4 | Short on either side | 99.78% | 99.78% |
| | of control box | | |
| FIG. 5 | Short on inverter | 99.95% | 99.95% |
| | side of control box | | |
| FIG. 6 | Short on either side | 99.90% | 99.90% |
| | of control box | | |
| FIG. 7 | Short on either side | 99.90% | 99.90% |
| | of control box | | |
| FIG. 8 | Short on either side | 99.88% | 99.88% |
| | of control box | | |

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), single-board computer (SBC), system on chip (SoC), system in package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” at least in some examples refers to, is part of, or includes circuitry capable of sequentially and automatically carrying out a sequence of arithmetic or logical operations, or recording, storing, and/or transferring digital data. The term “processor circuitry” at least in some examples refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” at least in some examples refers to one or more hardware devices for storing data, including random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, read-only memory (ROM), programmable ROM (PROM), erasable PROM (EPROM), electrically EPROM (EEPROM), flash memory, non-volatile RAM (NVRAM), magnetic disk storage mediums, optical storage mediums, flash memory devices or other machine readable mediums for storing data. The term “computer-readable medium” includes, but is not limited to, memory, portable or fixed storage devices, optical storage devices, and various other mediums capable of storing, containing or carrying instructions or data.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “server” at least in some examples refers to a computing device or system, including processing hardware and/or process space(s), an associated storage medium such as a memory device or database, and, in some instances, suitable application(s) as is known in the art. The terms “server system” and “server” may be used interchangeably herein, and these terms at least in some examples refers to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers includes an operating system (OS) that provides executable program instructions for the general administration and operation of the individual server computer devices, and includes a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. An electrical control box interfacing a battery to an inverter, the electrical control box comprising:
a first fuse connecting to a positive pole of the battery;
a second fuse connecting to a negative pole of the battery; and
at least one semiconductor switch on at least one of the positive pole or the negative pole,
wherein the at least one semiconductor switch is configured to stop current flow to a short on at least a first side of the electrical control box proximate to the battery or a second side of the electrical control box proximate to the inverter.

2. The electrical control box of claim 1, wherein the at least one semiconductor switch consists of an insulated-gate bipolar transistor (IGBT) module on the positive pole and configured to stop current flow to a short on the second side of the electrical control box and allow current flow to a short on the first side of the electrical control box.

3. The electrical control box of claim 1, wherein the at least one semiconductor switch comprises two anti-parallel discrete IGBTs on the positive pole, wherein a first of the two anti-parallel discrete IGBTs stops current flow to a short on the first side of the electrical control box, and wherein a second of the two anti-parallel discreate IGBTs stops current flow to a short on the second side of the electrical control box.

4. The electrical control box of claim 1, wherein the at least one semiconductor switch comprises two anti-series IGBT modules on the positive pole, wherein a first of the two anti-series IGBT modules proximate the first side of the electrical control box stops current flow to a short on the second side of the electrical control box, and wherein a second of the two anti-series IGBT modules proximate the second side of the electrical control box stops current flow to a short on the first side of the electrical control box.

5. The electrical control box of claim 1, wherein the at least one semiconductor switch comprises two anti-series IGBT modules, wherein a first of the two anti-series IGBT modules is on the positive pole and is configured to stop current flow to a short on the second side of the electrical control box, and wherein a second of the two anti-series IGBT modules is on the negative pole and is configured to stop current flow to a short on the first side of the electrical control box.

6. The electrical control box of claim 1, wherein the at least one semiconductor switch consists of a metal-oxide-semiconductor field-effect transistor (MOSFET) on the positive pole and configured to stop current flow to a short on the second side of the electrical control box.

7. The electrical control box of claim 1, wherein the at least one semiconductor switch consists of two anti-series MOSFETs on the positive pole, wherein a first of the two anti-series MOSFETs proximate to the first side of the electrical control box is configured to stop current flow to a short on the second side of the electrical control box, and wherein a second of the two anti-series MOSFETs proximate to the second side of the electrical control box is configured to stop current flow to a short on the first side of the electrical control box.

8. The electrical control box of claim 1, wherein the at least one semiconductor switch consists of two anti-series MOSFETs, wherein a first of the two anti-series MOSFETs is on the positive pole and is configured to stop current flow to a short on the second side of the electrical control box, and wherein a second of the two anti-series MOSFETs is on the negative pole and is configured to stop current flow to a short on the first side of the electrical control box.

9. The electrical control box of claim 1, wherein the at least one semiconductor switch consists of two anti-parallel gate turn-off thyristors (GTOs) on the positive pole, wherein a first of the two anti-parallel GTOs stops current flow to a short on the first side of the control box, and wherein a second of the two anti-parallel GTOs stops current flow to a short on the second side of the control box.

10. A system for interfacing a battery to an inverter, the system comprising:
a battery;
an inverter; and
an electrical control box interfacing the battery to the inverter, wherein the electrical control box comprises:
a first fuse connecting to a positive pole of the battery;
a second fuse connecting to a negative pole of the battery; and
at least one semiconductor switch on at least one of the positive pole or the negative pole,
wherein the at least one semiconductor switch is configured to stop current flow to a short on at least a first side of the electrical control box proximate to the battery or a second side of the electrical control box proximate to the inverter.

11. The system of claim 10, wherein the at least one semiconductor switch consists of an insulated-gate bipolar transistor (IGBT) module on the positive pole and configured to stop current flow to a short on the second side of the electrical control box and allow current flow to a short on the first side of the electrical control box.

12. The system of claim 10, wherein the at least one semiconductor switch comprises two anti-parallel discrete IGBTs on the positive pole, wherein a first of the two anti-parallel discrete IGBTs stops current flow to a short on the first side of the electrical control box, and wherein a second of the two anti-parallel discreate IGBTs stops current flow to a short on the second side of the electrical control box.

13. The system of claim 10, wherein the at least one semiconductor switch comprises two anti-series IGBT modules on the positive pole, wherein a first of the two anti-series IGBT modules proximate the first side of the electrical control box stops current flow to a short on the second side of the electrical control box, and wherein a second of the two anti-series IGBT modules proximate the second side of the electrical control box stops current flow to a short on the first side of the electrical control box.

14. The system of claim 10, wherein the at least one semiconductor switch comprises two anti-series IGBT modules, wherein a first of the two anti-series IGBT modules is on the positive pole and is configured to stop current flow to a short on the second side of the electrical control box, and wherein a second of the two anti-series IGBT modules is on the negative pole and is configured to stop current flow to a short on the first side of the electrical control box.

15. The system of claim 10, wherein the at least one semiconductor switch consists of a metal-oxide-semiconductor field-effect transistor (MOSFET) on the positive pole and configured to stop current flow to a short on the second side of the electrical control box.

16. The system of claim 10, wherein the at least one semiconductor switch consists of two anti-series MOSFETs on the positive pole, wherein a first of the two anti-series MOSFETs proximate to the first side of the electrical control box is configured to stop current flow to a short on the second side of the electrical control box, and wherein a second of the two anti-series MOSFETs proximate to the second side of the electrical control box is configured to stop current flow to a short on the first side of the electrical control box.

17. The system of claim 10, wherein the at least one semiconductor switch consists of two anti-series MOSFETs, wherein a first of the two anti-series MOSFETs is on the positive pole and is configured to stop current flow to a short on the second side of the electrical control box, and wherein a second of the two anti-series MOSFETs is on the negative pole and is configured to stop current flow to a short on the first side of the electrical control box.

18. The system of claim 10, wherein the at least one semiconductor switch consists of two anti-parallel gate turn-off thyristors (GTOs) on the positive pole, wherein a first of the two anti-parallel GTOs stops current flow to a short on the first side of the control box, and wherein a second of the two anti-parallel GTOs stops current flow to a short on the second side of the control box.

19. A device for interfacing a battery to an inverter, the device comprising:
a first fuse connecting to a positive pole of the battery;
a second fuse connecting to a negative pole of the battery; and
at least one semiconductor switch on at least one of the positive pole or the negative pole,
wherein the at least one semiconductor switch is configured to stop current flow to a short on at least a first side of the electrical control box proximate to the battery or a second side of the electrical control box proximate to the inverter.

20. The device of claim 19, wherein the at least one semiconductor switch comprises an insulated-gate bipolar transistor (IGBT) module, two anti-parallel discrete IGBTs, two anti-series IGBT modules, a metal-oxide-semiconductor field-effect transistor (MOSFET), two anti-series MOSFETs, or two anti-parallel gate turn-off thyristors (GTOs).
